(19) United States
(12) Patent Application Publication
(10) Pub. No.: US 2024/0429573 A1
(43) Pub. Date: Dec. 26, 2024

(54) SOLID-STATE BATTERY AND ELECTRONIC DEVICE

(71) Applicant: Murata Manufacturing Co., Ltd., Nagaokakyo-shi (JP)

(72) Inventors: Katsuaki HIGASHI, Nagaokakyo-shi (JP); Yoshihito NIWA, Nagaokakyo-shi (JP)

(21) Appl. No.: 18/823,752

(22) Filed: Sep. 4, 2024

Related U.S. Application Data
(63) Continuation of application No. PCT/JP2023/010428, filed on Mar. 16, 2023.

(30) Foreign Application Priority Data
Mar. 29, 2022 (JP) 2022-054371

(51) Int. Cl. H01M 50/562; H01M 10/0525; H01M 10/0562

(52) U.S. Cl. CPC H01M 50/562; H01M 10/0525; H01M 10/0562; H01M 2300/0071

(57) ABSTRACT

A solid-state battery that includes: a battery element body including a positive electrode layer, a negative electrode layer, and a solid-state electrolyte layer interposed between the positive electrode layer and the negative electrode layer; and a terminal electrode on an end surface of the battery element body and electrically connected to the battery element body, wherein the terminal electrode contains a conductive material and a polyester-based resin.

### CROSS REFERENCE TO RELATED APPLICATIONS

The present application is a continuation of International application No. PCT/JP2023/010428, filed Mar. 16, 2023, which claims priority to Japanese Patent Application No. 2022-054371, filed Mar. 29, 2022, the entire contents of each of which are incorporated herein by reference.

### TECHNICAL FIELD

The present disclosure relates to a solid-state battery and an electronic device.

### BACKGROUND ART

Conventionally, secondary batteries that can be repeatedly charged and discharged have been used for various purposes. For example, the secondary battery is used as a power supply of an electronic device such as a smartphone and a notebook computer.

In a secondary battery, a liquid electrolyte is generally used as a medium for ion transfer that contributes to charge and discharge. That is, a so-called electrolytic solution is used for the secondary battery. However, in such a secondary battery, safety is generally required in terms of preventing leakage of the electrolytic solution. Since an organic solvent or the like used for the electrolytic solution is a flammable substance, safety is required also in that respect.

Therefore, a solid-state battery using a solid-state electrolyte instead of the electrolytic solution has been studied.
Patent Document 1: Japanese Patent Application Laid-Open No. 2015-220107
Patent Document 2: Japanese Patent Application Laid-Open (Translation of PCT Application) No. 2010-503957

### SUMMARY OF THE DISCLOSURE

The solid-state battery includes an element body including a battery constituent unit including a positive electrode layer, a negative electrode layer, and a solid-state electrolyte therebetween, and includes terminal electrodes electrically connected to the positive electrode layer and the negative electrode layer, respectively. Here, Patent Document 1 discloses that a material having high conductivity is selected as a terminal electrode, and silver, gold, platinum, aluminum, copper, tin, and nickel are employed.

However, there has been a demand for further improvement in electrical characteristics and reliability characteristics of the solid-state battery.

The present disclosure has been made in view of such a demand. That is, a main object of the present disclosure is to provide a solid-state battery and an electronic device having high adhesiveness with respect to a terminal electrode of the solid-state battery.

The inventors of the present application have attempted to solve the above-described problems by addressing the problems in a new direction rather than addressing the problems as an extension of the prior art. As a result, the present inventors have reached a solid-state battery in which the main object is achieved.

A solid-state battery according to the present disclosure includes: a battery element body including a positive electrode layer, a negative electrode layer, and a solid-state electrolyte layer interposed between the positive electrode layer and the negative electrode layer; and a terminal electrode on an end surface of the battery element body and electrically connected to the battery element body, wherein the terminal electrode contains a conductive material and a polyester-based resin.

On an electronic device according to the present disclosure, the solid-state battery described above is surface-mounted.

According to the solid-state battery and the electronic device according to the present disclosure, it is possible to provide a solid-state battery and an electronic device having high adhesiveness with respect to a terminal electrode.

### BRIEF EXPLANATION OF THE DRAWINGS

FIG. 1 is a sectional view of a main portion of a solid-state battery according to the present disclosure.

FIG. 2A is a schematic view of a main portion of the solid-state battery according to the present disclosure.

FIG. 2B is a schematic view of a main portion of the solid-state battery according to the present disclosure.

FIG. 3 is a sectional view of a main portion of the solid-state battery according to the present disclosure.

### DESCRIPTION OF THE PREFERRED EMBODIMENTS

Hereinafter, the “solid-state battery” of the present disclosure and the “electronic device” on which the solid-state battery is surface-mounted will be described in detail. Although the description will be made with reference to the drawings as necessary, the illustrated contents are only schematically and exemplarily illustrated for the understanding of the present disclosure, and the appearance, the dimensional ratio, or the like may be different from the actual ones.

First, the “solid-state battery” according to one embodiment of the present disclosure will be described. The “solid-state battery” referred to in the present disclosure refers to a battery whose constituent elements are composed of a solid in a broad sense, and refers to an all-solid-state battery whose battery constituent elements (particularly preferably all battery constituent elements) are composed of a solid in a narrow sense. In a preferred embodiment, the solid-state battery in the present disclosure is a stacked solid-state battery configured such that layers constituting a battery constituent unit are stacked with each other, and preferably such layers may be made of a sintered body. Note that the “solid-state battery” includes not only a so-called “secondary battery” capable of repeating charging and discharging but also a “primary battery” capable of only discharging. According to a preferred embodiment of the present disclosure, the “solid-state battery” is a secondary battery. The “secondary battery” is not excessively limited by its name, and may include, for example, a power storage device and the like.

The term “plan view” as used in the present specification is based on a form in a case where an object is captured from an upper side or a lower side along a thickness direction based on a stacking direction of each layer constituting the solid-state battery. The term “sectional view” used in the present specification is on the basis of a form in the case of viewing an object from a direction substantially perpendicular to the thickness direction based on the stacking direction in which each layer constituting the solid-state battery is stacked (to put it briefly, a form in the case of cutting an object along a plane parallel to the thickness direction). The terms “vertical direction” and “horizontal direction” used directly or indirectly in the present specification correspond to a vertical direction and a horizontal direction in the drawings, respectively. Unless otherwise specified, the same symbols or signs shall denote the same members or sites or the same meanings. In a preferred embodiment, it can be grasped that a vertical downward direction (that is, a direction in which gravity acts) corresponds to a “downward direction”, and the opposite direction corresponds to an “upward direction”.

### [Configuration of Solid-State Battery]

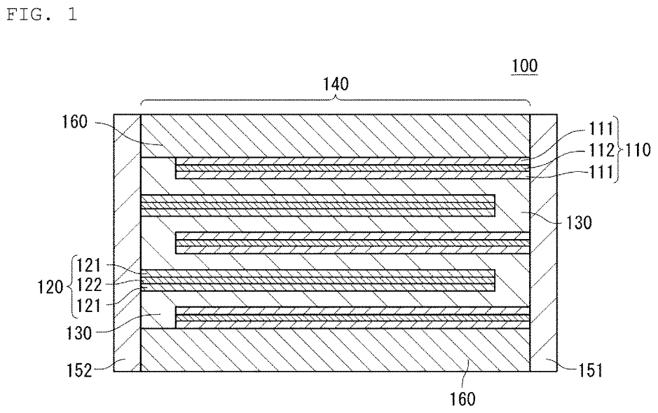

A solid-state battery 100 includes a battery element body 140 including a battery constituent unit including a positive electrode layer 110, a negative electrode layer 120, and a solid-state electrolyte layer 130 interposed therebetween at least, and terminal electrodes 151, 152 (refer to FIG. 1). More specifically, the terminal electrodes 151, 152 are in contact with the outer surface of the battery element body 140.

### 1. Battery Element Body

The battery element body 140 may be formed by firing each layer that constitutes the battery element body. The positive electrode layer 110, the negative electrode layer 120, the solid-state electrolyte layer 130, and the like may form a sintered layer. Preferably, the positive electrode layer, the negative electrode layer, and the solid-state electrolyte are integrally fired with each other may be formed of a sintered body. Therefore, the battery element body may form an integrally sintered body. In the present specification, a direction (vertical direction) in which the positive electrode layer and the negative electrode layer are stacked is referred to as a “stacking direction”, and a direction intersecting the stacking direction is a horizontal direction in which the positive electrode layer and the negative electrode layer extend.

### 1-1. Positive Electrode Layer and Negative Electrode Layer

The positive electrode layer 110 is an electrode layer including at least a positive electrode active material layer 111. The positive electrode layer 110 may further contain a solid-state electrolyte. In a preferred aspect, the positive electrode layer 110 may be formed of a sintered body including at least positive electrode active material particles and solid-state electrolyte particles. On the other hand, the negative electrode layer 120 may be an electrode layer including at least a negative electrode active material layer 121. The negative electrode layer 120 may further contain a solid-state electrolyte. In a preferred embodiment, the negative electrode layer 120 may be formed of a sintered body containing at least negative electrode active material particles and solid-state electrolyte particles.

Here, the positive electrode active material and the negative electrode active material are substances involved in accepting and donating electrons in the solid-state battery. Ion movement (or conduction) between the positive electrode layer and the negative electrode layer with the solid-state electrolyte interposed therebetween and accepting and donating of electrons between the positive electrode layer and the negative electrode layer with an external terminal interposed therebetween are performed, so that charge and discharge are performed. The positive electrode layer 110 and the negative electrode layer 120 may include a current collector layer.

Although FIG. 1 illustrates a configuration in which three positive electrode layers 110 and two negative electrode layers 120 are stacked, the number of stacked layers is not limited to this example, and the number of stacked layers may be one, or several tens to several hundreds of layers may be stacked. The film thickness of the positive electrode layer or the negative electrode layer may be 5 μm to 60 μm, and preferably 8 μm to 50 μm. The film thickness may be 5 μm to 30 μm.

### (Positive Electrode Active Material Layer)

The positive electrode active material contained in the positive electrode active material layer 111 is, for example, a lithium-containing compound or a sodium-containing compound. That is, it may be a layer capable of occluding and releasing lithium ions or sodium ions. The type of the lithium-containing compound is not particularly limited, and examples of the lithium-containing compound include a lithium transition metal composite oxide and/or a lithium transition metal phosphate compound. The lithium transition metal composite oxide is a generic term for oxides containing lithium and one or two or more types of transition metal elements as constituent elements. The lithium transition metal phosphate compound is a generic term for phosphate compounds containing lithium and one or two or more types of transition metal elements as constituent elements. The type of transition metal element is not particularly limited, and examples of the type include cobalt (Co), nickel (Ni), manganese (Mn), and/or iron (Fe).

The lithium transition metal composite oxide is, for example, a compound represented by LiₓM1O₂ and Li_{y}M2O₄. The lithium transition metal phosphate compound is, for example, a compound represented by Li_{z}M₃PO₄. Note that, each of M1, M2, and M3 is one or two or more types of transition metal elements. The respective values of x, y and z are any values.

Specifically, examples of the lithium transition metal composite oxide include LiCoO₂, LiNiO₂, LiVO₂, LiCrO₂, LiMn₂O₄, LiCo_{1/3}Ni_{1/3}Mn_{1/3}O₂, and LiNi_{0.5}Mn_{1.5}O₄. Examples of the lithium transition metal phosphate compound include LiFePO₄, LiCoPO₄, and LiMnPO₄. The lithium transition metal composite oxide (particularly LiCoO₂) may contain a trace amount (about several %) of an additive element. Examples of the additive element include one or more types of elements selected from the group consisting of aluminum (Al), magnesium (Mg), nickel (Ni), manganese (Mn), titanium (Ti), boron (B), vanadium (V), chromium (Cr), iron (Fe), copper (Cu), zinc (Zn), molybdenum (Mo), tin (Sn), tungsten (W), zirconium (Zr), yttrium (Y), niobium (Nb), calcium (Ca), strontium (Sr), bismuth (Bi), sodium (Na), potassium (K), and silicon (Si).

In addition, examples of the positive electrode active material capable of occluding and releasing sodium ions include at least one selected from the group consisting of sodium-containing phosphate compounds having a NASICON-type structure, sodium-containing phosphate compounds having an olivine-type structure, sodium-containing layered oxides, sodium-containing oxides having a spinel-type structure, and the like. For example, in the case of the sodium-containing phosphate compounds, examples thereof include at least one selected from the group consisting of Na₃V₂(PO₄)₃, NaCoFe₂(PO₄)₃, Na₂Ni₂Fe(PO₄)₃, Na₃Fe₂(PO₄)₃, Na₂FeP₂O₇, Na₄Fe₃(PO₄)₂(P₂O₇), and NaFeO₂ as a sodium-containing layered oxide.

In addition, the positive electrode active material may be, for example, an oxide, a disulfide, a chalcogenide, a conductive polymer, or the like. The oxide may be, for example, a titanium oxide, a vanadium oxide, a manganese dioxide, or the like. The disulfide is, for example, a titanium disulfide, a molybdenum sulfide, or the like. The chalcogenide may be, for example, a niobium selenide or the like. The conductive polymer may be, for example, a disulfide, a polypyrrole, a polyaniline, a polythiophene, a poly-para-styrene, a polyacetylene, a polyacene, or the like.

The content of the positive electrode active material in the positive electrode active material layer 111 is usually 50 wt % or more, for example, 60 wt % or more with respect to the total amount of the positive electrode active material layer 111. The positive electrode active material layer 111 may contain two or more types of the positive electrode active materials, and in that case, the total content thereof may be within the above range. When the content of the active material is 50 mass % or more, the energy density of the battery can be particularly increased.

### (Negative Electrode Active Material Layer)

Examples of the negative electrode active material contained in the negative electrode active material layer 121 include a carbon material, a metal-based material, a lithium alloy and/or a lithium-containing compound.

Specifically, examples of the carbon material include graphite, graphitizable carbon, non-graphitizable carbon, mesocarbon microbeads (MCMB), and/or highly oriented graphite (HOPG).

The metal-based material is a generic term for a material containing any one or two or more types of metal elements and metalloid elements capable of forming alloy with lithium as constituent elements. The metal-based material may be a simple substance, an alloy, or a compound. Since the purity of the simple substance described here is not necessarily limited to 100%, the simple substance may contain a trace amount of impurities.

Examples of the metal element and the metalloid element include silicon (Si), tin (Sn), aluminum (Al), indium (In), magnesium (Mg), boron (B), gallium (Ga), germanium (Ge), lead (Pb), bismuth (Bi), cadmium (Cd), titanium (Ti), chromium (Cr), iron (Fe), niobium (Nb), molybdenum (Mo), silver (Ag), zinc (Zn), hafnium (Hf), zirconium (Zr), yttrium (Y), palladium (Pd), and/or platinum (Pt).

Specifically, examples of the metal-based material include Si, Sn, SiB₄, TiSi₂, SiC, Si₃N₄, SiO, (0<v≤2), LiSiO, SnO_{w} (0<w≤2), SnSiO₃, LiSnO, and/or Mg₂Sn.

The lithium-containing compound is, for example, a lithium transition metal composite oxide. The definition regarding the lithium transition metal composite oxide is as described above. Specifically, the lithium transition metal composite oxide is, for example, Li₃V₂(PO₄)₃, Li₃Fe₂(PO₄)₃, Li₄Ti₅O₁₂, LiTi₂(PO₄)₃, and/or LiCuPO₄.

Examples of the negative electrode active material capable of occluding and releasing sodium ions include at least one selected from the group consisting of a sodium-containing phosphate compound having a NASICON-type structure, a sodium-containing phosphate compound having an olivine-type structure, a sodium-containing oxide having a spinel-type structure, and the like.

The content of the negative electrode active material in the negative electrode active material layer 121 is usually 50 wt % or more, for example, 60 wt % or more with respect to the total amount of the negative electrode active material portion. The negative electrode active material portion may contain two or more types of negative electrode active materials, and in that case, the total content thereof may be within the above range. When the content of the active material is 50 mass % or more, the energy density of the battery can be particularly increased.

### (Additional Configuration of Positive Electrode Active Material Layer and Negative Electrode Active Material Layer)

The positive electrode active material layer 111 and/or the negative electrode active material layer 121 may contain a conductive material. Examples of the conductive material contained in the positive electrode active material layer 111 and/or the negative electrode active material layer 121 include a carbon material and a metal material. Specific examples of the carbon material include graphite and carbon nanotubes. Examples of the metal material include copper (Cu), magnesium (Mg), titanium (Ti), iron (Fe), cobalt (Co), nickel (Ni), zinc (Zn), aluminum (Al), germanium (Ge), indium (In), gold (Au), platinum (Pt), silver (Ag), and/or palladium (Pd), and an alloy of two or more of them.

The positive electrode active material layer 111 and/or the negative electrode active material layer 121 may contain a binder. The binder is, for example, any one or two or more types of synthetic rubbers and polymer materials. Specifically, examples of the synthetic rubber include styrene-butadiene-based rubber, fluorine-based rubber, and/or ethylene propylene diene. Examples of the polymer material include at least one selected from the group consisting of polyvinylidene fluoride, polyimide, and an acrylic resin.

Further, the positive electrode active material layer 111 and/or the negative electrode active material layer 121 may contain a sintering aid. Examples of the sintering aid include at least one selected from the group consisting of lithium oxide, sodium oxide, potassium oxide, boron oxide, silicon oxide, bismuth oxide, and phosphorus oxide.

The thickness of each of the positive electrode active material layer 111 and the negative electrode active material layer 121 is not particularly limited, and may be, for example, 2 μm to 100 μm, and particularly 5 μm to 50 μm, independently of each other.

### (Positive Electrode Current Collector Layer and Negative Electrode Current Collector Layer)

A positive electrode current collector layer 112 and a negative electrode current collector layer 122 preferably have higher electron conductivity than those of the positive electrode active material layer 111 and the negative electrode active material layer 121.

As the positive electrode current collector layer 112, for example, at least one selected from the group consisting of a carbon material, silver, palladium, gold, platinum, aluminum, copper, a nickel lithium transition metal composite oxide, and a lithium transition metal phosphate compound may be used.

As the negative electrode current collector layer 122, for example, at least one selected from the group consisting of a carbon material, silver, palladium, gold, platinum, aluminum, copper, and nickel may be used.

Each of the positive electrode current collector layer 112 and/or the negative electrode current collector layer 122 may have an electrical connection portion for electrical connection with the outside, and may be configured to be electrically connectable to a terminal electrode. Each of the positive electrode current collector layer 112 and the negative electrode current collector layer 122 may be in the form of a foil. The positive electrode current collector layer 112 and the negative electrode current collector layer 122 are preferably in the form of an integral sintering from the viewpoint of improvement in conductivity and reduction in manufacturing cost due to integral sintering.

When the positive electrode current collector layer 112 and/or the negative electrode current collector layer 122 are in the form of a fired body, for example, the positive electrode current collector layer 112 and/or the negative electrode current collector layer 122 may be composed of a sintered body containing a conductive material, an active material, a solid-state electrolyte, a binder, and/or a sintering aid. The conductive material contained in the positive electrode current collector layer 112 and the negative electrode current collector layer 122 may be selected from, for example, materials similar to the conductive material that can be contained in the positive electrode active material layer 111 and/or the negative electrode active material layer 121. Note that, in the solid-state battery, the positive electrode current collector layer 112 and the negative electrode current collector layer 122 are not essential, and a solid-state battery in which such a positive electrode current collector layer 112 and a negative electrode current collector layer 122 are not provided is also conceivable. That is, the solid-state battery in the present disclosure may be a solid-state battery without a current collecting layer.

The positive electrode current collector layer 112 and/or the negative electrode current collector layer 122 may also contain a heat-resistant resin. When the current collector layer contains a heat-resistant resin, cracks generated by expansion of the current collector layer can be suppressed.

The thickness of each of the positive electrode current collector layer 112 and the negative electrode current collector layer 122 is not particularly limited, and may be, for example, 1 μm to 100 μm, and particularly 1 μm to 50 μm, independently of each other.

### 1-2. Solid-State Electrolyte Layer

The solid-state electrolyte constituting the solid-state electrolyte layer 130 is a material capable of conducting lithium ions or sodium ions. In particular, the solid-state electrolyte constituting a battery constituent unit in the solid-state battery forms a layer capable of conducting lithium ions or sodium ions between the positive electrode layer 110 and the negative electrode layer 120. The solid-state electrolyte layer has only to be provided at least between the positive electrode layer 110 and the negative electrode layer 120. That is, the solid-state electrolyte layer may also exist around the positive electrode layer 110 and/or the negative electrode layer 120 so as to protrude in the horizontal direction from between the positive electrode layer 110 and the negative electrode layer 120. Specific examples of the solid-state electrolyte include any one or two or more types of a crystalline solid-state electrolyte, a glass-based solid-state electrolyte, and a glass ceramic-based solid-state electrolyte.

Examples of the crystalline solid-state electrolyte include oxide-based crystal materials and sulfide-based crystal materials. Examples of the oxide-based crystal materials include lithium-containing phosphate compounds that have a NASICON structure, oxides that have a perovskite structure, oxides that have a garnet-type or garnet-type similar structure, and oxide glass ceramic-based lithium ion conductors. Examples of the lithium-containing phosphate compounds that have a NASICON structure include LiₓM_{y}(PO₄)₃ (1≤x≤2, 1≤y≤2, M is at least one selected from the group consisting of titanium (Ti), germanium (Ge), aluminum (Al), gallium (Ga), and zirconium (Zr)). As an example of the lithium-containing phosphate compound having a NASICON structure, Li_{1.2}Al_{0.2}Ti_{1.8}(PO₄)₃ and the like can be mentioned, for example. Examples of the oxides that have a perovskite structure include La_{0.55}Li_{0.35}TiO₃. Examples of the oxides that have a garnet-type or garnet-type similar structure include Li₇La₃Zr₂O₁₂. In addition, examples of the sulfide-based crystal materials include thio-LISICON, for example, Li_{3.25}Ge_{0.25}P_{0.75}S₄ and Li₁₀GeP₂S₁₂. The crystalline solid-state electrolyte may contain a polymer material (for example, a polyethylene oxide (PEO)).

Examples of the glass-based solid-state electrolyte include oxide-based glass materials and sulfide-based glass materials. In addition, examples of the oxide-based glass material include Li₂O—SiO₂, Li₂O—Al₂O₃—TiO₂—P₂O₅, 54Li₂O-11SiO₂-35B₂O₃, 50Li₄SiO₄-50Li₃BO₃, 23.3Li₂O-76.7GeO₂, and 60Li₂O-40P₂O₅. In other words, the oxide-based glass material may contain at least one selected from the group consisting of lithium, silicon, and boron. The oxide-based glass material essentially contains lithium oxide, and may contain at least one selected from the group consisting of germanium oxide, silicon oxide, boron oxide, and phosphorus oxide. In addition, examples of the sulfide-based glass material include 30Li₂S-26B₂S₃-44LiI, 63Li₂S-36SiS₂-1Li₃PO₄, 57Li₂S-38SiS₂-5Li₄SiO₄, 70Li₂S-30P₂S₅, and 50Li₂S-50GeS₂.

Examples of the glass ceramic-based solid-state electrolyte include oxide-based glass ceramic materials and sulfide-based glass ceramic materials. As the oxide-based glass ceramic materials, for example, a phosphate compound (LATP) containing lithium, aluminum, and titanium as constituent elements, and a phosphate compound (LAGP) containing lithium, aluminum, and germanium as constituent elements can be used. LATP is, for example, Li_{1.07}Al_{0.69}Ti_{1.46}(PO₄)₃. LAGP is, for example, Li_{1.5}Al_{0.5}Ge_{1.5}(PO₄). In other words, the oxide-based glass ceramic material may contain at least one selected from the group consisting of lithium, silicon, and boron. Examples thereof include 90Li₃BO₃-10Li₂SO₄. The oxide-based glass ceramic material essentially contains lithium oxide, and may contain at least one selected from the group consisting of germanium oxide, silicon oxide, boron oxide, and phosphorus oxide. In addition, examples of the sulfide-based glass ceramic material include Li₇P₃S₁₁ and Li_{3.25}P_{0.95}S₄.

When more emphasis is placed on the viewpoint of achieving excellent atmospheric stability and easy integral sintering, the solid-state electrolyte may contain at least one selected from the group consisting of an oxide-based crystal material, an oxide-based glass material, and an oxide-based glass ceramic material.

Examples of the solid-state electrolyte capable of conducting sodium ions include a sodium-containing phosphate compound having a NASICON structure, an oxide having a perovskite structure, and an oxide having a garnet-type structure or a garnet-type similar structure. Examples of the sodium-containing phosphate compound having a NASICON structure include NaₓM_{y}(PO₄)₃ (1≤x≤2, 1≤y≤2, and M is at least one selected from the group consisting of Ti, Ge, Al, Ga, and Zr).

The solid-state electrolyte layer may contain a binder and/or a sintering aid. The binder and/or the sintering aid contained in the solid-state electrolyte layer may be selected from, for example, materials similar to the binder and/or the sintering aid that can be contained in the positive electrode active material portion and/or the negative electrode active material portion.

The thickness of the solid-state electrolyte layer is not particularly limited, and may be, for example, 1 μm to 15 μm, particularly 1 μm to 5 μm.

### 2. Terminal Electrode

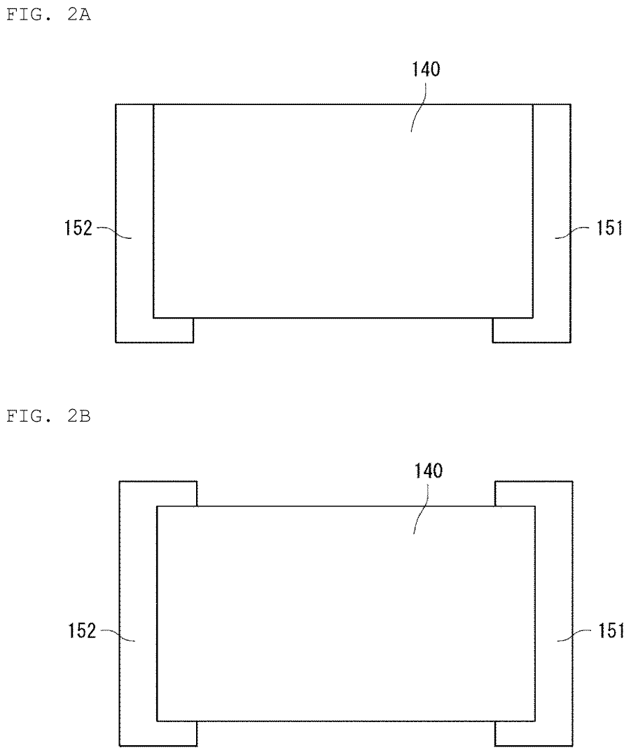

The terminal electrode is provided on an end surface of the battery element body 140. As an example, in FIG. 1, the terminal electrodes 151,152 may be provided on each side surface of the battery element body 140 located in a direction intersecting the stacking direction of the battery element body 140. As a modification of the terminal electrodes 151,152, as illustrated in FIG. 2A, the terminal electrode may extend from the side surface of the battery element body 140 to the bottom surface of the battery element body. Further, as another modification, as illustrated in FIG. 2B, a terminal electrode may be provided from a side surface to a bottom surface and/or a top surface of the battery element body 140.

More specifically, the terminal electrode may be provided with a positive electrode-side terminal electrode 151 connected to the positive electrode layer 110 and a negative electrode-side terminal electrode 152 connected to the negative electrode layer 120, and the positive electrode-side terminal electrode 151 may be formed on one side surface (the right side in FIG. 1), and the negative electrode-side terminal electrode 152 may be provided so as to face the positive electrode-side terminal electrode 151 (the left side in FIG. 1).

The terminal electrodes 151, 152 contain a conductive material and a polyester-based resin. Here, as a terminal electrode of a conventional solid-state battery, a terminal electrode made only of a conductive material is known. This terminal electrode was formed by providing a conductive paste on a battery element body and firing the conductive paste. Since the firing temperature of the conductive paste was about 800° C., it was not suitable for a battery element body having glass lower than the firing temperature. Therefore, a terminal electrode containing a conductive material and a resin material has been used for the purpose of lowering the temperature for forming the terminal electrode. In particular, when a polyester-based resin is contained as a material for forming the terminal electrode, it is possible to reduce cracks in the terminal electrode due to volume expansion generated when the solid-state battery is charged. Hereinafter, the terminal electrode will be described in detail.

### (Conductive Material)

The conductive material is a material having conductivity, and specific examples thereof include a carbon material and a metal material. The term “conductive” as used herein means that the volume resistivity is 107 Ω·cm or less.

The metal material is not particularly limited as long as it has conductivity, and examples thereof include at least one selected from the group consisting of silver, gold, platinum, aluminum, copper, palladium, zinc, tin, and nickel. In addition, a composite metal such as Ag-coated Cu or Ag-coated CuNi may be used. Incidentally, silver is exemplified as a preferable metal material because the conductivity is high and the change in conductivity is small as well under a high-temperature and high-humidity environment.

The shape of the conductive material is preferably spherical, dendritic, or flat. The term “flat shape” as used herein includes an elliptical shape having a curved shape in which an arc portion having a large radius of curvature and an arc portion having a small radius of curvature are coupled, an elliptical shape having a shape in which an arc portion and a flat portion are coupled, and the like. Note that a perfect circle may be included. The particle size of the particles is not limited, and is preferably 0.1 μm to 30 μm.

### (Polyester-Based Resin)

The polyester-based resin is used for further improving the adhesiveness between the terminal electrode and the battery element body. The term “polyester-based resin” as used herein refers to a resin obtained by polycondensation of a polybasic acid and a polyhydric alcohol and having an ester bond therein. As an example of the polybasic acid, a polyvalent carboxylic acid (for example, dicarboxylic acids) is preferable. As an example of the polyhydric alcohol, a polyalcohol (for example, diols) is preferable.

In the present embodiment, since the terminal electrodes 151, 152 contains a polyester-based resin, the terminal electrodes 151, 152 can be firmly bonded to the battery element body 140. In addition, since the terminal electrodes 151, 152 of the solid-state battery 100 can follow the volume expansion of the battery element body 140 generated when the solid-state battery is charged, the occurrence of cracks in the terminal electrodes 151, 152 can be suppressed. The point of suppressing the occurrence of cracks in the terminal electrodes 151, 152 will be described in detail when describing the “elongation at break” and the “Young's modulus” in Examples described later.

### 3. Insulating Outer Layer

As an additional configuration of the solid-state battery of the present disclosure, an insulating outer layer 160 may be provided. Specifically, an insulating outer layer 160 may be provided outside the battery element body 140. The insulating outer layer 160 can be generally formed on the outermost side of the battery element body 140, and used to electrically, physically, and/or chemically protect the battery element body 140. Particularly, the insulating outer layer 160 includes an insulating outer layer 160 on the top surface side of the solid-state battery 100 and an insulating outer layer 160 on the bottom surface side of the solid-state battery 100. In addition, an insulating outer layer 160 may be provided on a side surface of the battery element body 140 on which the terminal electrodes 151, 152 is not provided (a side surface of the battery element body 140 in a direction perpendicular to the paper surface in FIG. 1). The material constituting the insulating outer layer is preferably excellent in insulation property, durability and/or moisture resistance and environmentally safe, and may contain, for example, a resin material, a glass material and/or a ceramic material. Further, the insulating outer layer may have a form of a fired body for production by integral firing. Note that the insulating outer layer 160 may not be provided, and the insulating outer layer may be included in other resins or ceramic packages.

### 4. Covering Insulating Film

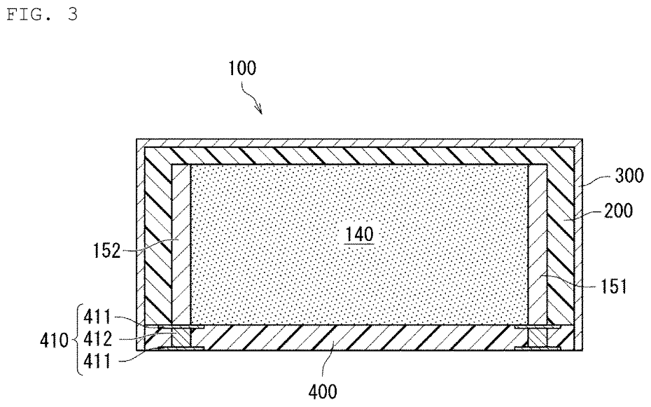

As an additional configuration of the solid-state battery of the present disclosure, a covering insulating film 200 may be provided. The covering insulating film 200 may be provided so as to cover the terminal electrodes 151, 152 and the battery element body 140 (refer to FIG. 3). The covering insulating film 200 preferably corresponds to a resin. That is, the covering insulating film 200 preferably contains a resin material. As can be seen from the aspect illustrated in FIG. 3, this means that the battery element body 140 provided on a support substrate 400 is sealed with a resin material of the covering insulating film 200. The covering insulating film 200 formed of such a resin material suitably contributes to reduction of entry of moisture in combination with an inorganic film 300.

The material of the covering insulating film may be any type as long as it exhibits insulating properties. For example, when the covering insulating film contains a resin, the resin may be either a thermosetting resin or a thermoplastic resin. Although not particularly limited, specific examples of the resin material of the covering insulating film include an epoxy-based resin, a silicone-based resin, and/or a liquid crystal polymer. Although it is merely an example, the thickness of the covering insulating film may be 30 μm to 1000 μm, and is, for example, 50 μm to 300 μm.

In the solid-state battery, the covering insulating film is not essential, and a solid-state battery in which the covering insulating film is not provided is also conceivable.

### 5. Inorganic Film

The solid-state battery of the present disclosure may be further provided with the inorganic film 300 covering the covering insulating film 200. As illustrated in FIG. 3, since the inorganic film 300 is positioned on the covering insulating film 200, the inorganic film largely encloses the battery element body 140 on the support substrate 400 as a whole together with the covering insulating film 200.

The inorganic film 300 preferably has a thin film form. A material of the inorganic film is not particularly limited as long as it contributes to the inorganic film having a thin film form, and may be metal, glass, oxide ceramics, a mixture thereof, or the like. In a preferred embodiment, the inorganic film contains a metal component. That is, the inorganic film is preferably a metal thin film. Although it is merely an example, the thickness of such an inorganic film may be 0.1 μm to 100 μm, and is, for example, 1 μm to 50 μm.

In particular, depending on the production method, the inorganic film 300 may be a dry plating film. Such a dry plating film is a film obtained by a vapor phase method such as physical vapor deposition (PVD) or chemical vapor deposition (CVD), and has a very small thickness on the nano order or the micron order. Such a thin dry plating film contributes to more compact packaging.

The dry plating film may contain, for example, at least one metal component/metalloid component selected from the group consisting of aluminum (Al), nickel (Ni), palladium (Pd), silver (Ag), tin (Sn), gold (Au), copper (Cu), titanium (Ti), platinum (Pt), silicon (Si), SUS, and the like, an inorganic oxide, a glass component, and/or the like. Since the dry plating film including such a component is chemically and/or thermally stable, a solid-state battery having excellent chemical resistance, weather resistance, heat resistance, and/or the like and further improved long-term reliability can be provided.

In the solid-state battery, the inorganic film is not essential, and a solid-state battery in which the inorganic film is not provided is also conceivable.

### 6. Support Substrate

As an additional configuration of the solid-state battery of the present disclosure, a support substrate 400 may be provided. The support substrate 400 is a substrate disposed so as to support the battery element body 140. The support substrate is positioned on one side that forms a main surface of the solid-state battery so as to serve as the “support”. The support substrate preferably has a thin plate-like form as a whole because of the “substrate”.

The support substrate 400 may be, for example, a resin substrate or a ceramic substrate, and is preferably a substrate having water resistance. In a preferred aspect, the support substrate 400 is a ceramic substrate. That is, the support substrate 400 contains ceramic, and the ceramic occupies a base material component of the substrate. The support substrate formed from ceramic contributes to prevention of water vapor transmission, and is thus a preferred substrate in terms of heat resistance and the like in substrate mounting. Such a ceramic substrate can be obtained through firing, and for example, can be obtained by firing a green sheet laminate. In this regard, the ceramic substrate may be, for example, a low temperature co-fired ceramics (LTCC) board or a high temperature co-fired ceramics (HTCC) board. Although it is merely an example, the thickness of the support substrate may be 20 μm to 1000 μm, and is, for example, 100 μm to 300 μm.

Further, the support substrate 400 may function as a terminal substrate of the battery element body 140. That is, the solid-state battery packaged in a form in which the substrate is interposed can be mounted on another secondary substrate such as a printed wiring board. For example, the solid-state battery can be surface-mounted with a support substrate interposed between the battery and device through solder reflow and the like. From the above, the packaged solid-state battery may be an SMD type battery. In particular, when the terminal substrate includes a ceramic substrate, the solid-state battery can be an SMD type battery having high heat resistance and being solder-mountable.

Because of the terminal substrate, it is preferable to include wiring, and in particular, it is preferable to include wiring 410 (refer to FIG. 3) that electrically connects upper and lower surfaces or upper and lower surface layers. That is, a support substrate of a preferred aspect includes wiring that electrically wires upper and lower surfaces of the substrate, and may be a terminal substrate for an external terminal of a packaged solid-state battery.

The wiring 410 in the terminal substrate is not particularly limited, and may have any form as long as it contributes to electrical connection between the upper surface and the lower surface of the substrate. Since the form contributes to electrical connection, it can be said that the wiring 410 in the terminal substrate is a conductive portion of the substrate. Such a conductive portion of the substrate may have the form of a wiring layer, a via, a land, and/or the like. For example, in the aspect illustrated in FIG. 3, vias 412 and/or lands 411 are provided in the support substrate 400. The “via” referred to herein refers to a member for electrically connecting the vertical direction of the support substrate, that is, the substrate thickness direction, and for example, a filled via or the like is preferable, and may be in the form of an inner via or the like. The term “land” used in the present specification refers to a terminal portion/connection portion (preferably a terminal portion/connection portion connected to the via) for electrical connection provided on an upper main surface and/or a lower main surface of the support substrate, and may be, for example, a corner land or a round land.

### [Configuration of Electronic Device]

In the electronic device of the present disclosure, the above-described solid-state battery is surface-mounted. Specifically, the wiring of the support substrate 400 enables surface mounting of the solid-state battery. The term “surface mounting” as used herein intends a technique for directly fixing a solid-state battery to a pattern formed on a substrate. As an example, the solid-state battery 1 described above may be mounted on a printed circuit board or the like and packaged. Further, electronic components other than the solid-state battery may be mounted.

### [Method for Producing Solid-State Battery]

The solid-state battery of the present disclosure is produced through a process including: (1) preparation of a battery element body; (2) preparation of a terminal electrode material; (3) firing of the battery element body; (4) application of the terminal electrode material; (5) curing of the terminal electrode material; (6) fixation to a support substrate; and (7) formation of a covering insulating film and an inorganic film. Hereinafter, description will be made in order.

### (1) Preparation of Battery Element Body

In the production of the battery element body, a sheet containing a solid-state electrolyte, a positive electrode paste, and a negative electrode paste are prepared.

As for the sheet containing a solid-state electrolyte, a slurry is prepared by mixing a solid-state electrolyte, an organic binder, a solvent, and an optional additive, and a sheet is formed from the prepared slurry by firing.

The positive electrode active material, the solid-state electrolyte, the conductive material, the organic binder, the solvent, and optional additives are mixed to prepare a positive electrode paste. Similarly, the negative electrode active material, the solid-state electrolyte, the conductive material, the organic binder, the solvent, and optional additives are mixed to prepare a negative electrode paste.

First, the positive electrode paste is applied by printing onto the sheet containing a solid-state electrolyte, and a current collecting layer and/or a negative layer are applied by printing, if necessary. Similarly, the negative electrode paste is applied by printing onto the sheet, and a current collecting layer and/or a negative layer are applied by printing, if necessary. The sheet with the positive electrode paste applied by printing and the sheet with the negative electrode paste applied by printing are alternately stacked to obtain a laminate. Further, the outermost layer (the uppermost layer and/or the lowermost layer) of the laminate may be an electrolyte layer, an insulating layer, or an electrode layer.

### (2) Preparation of Terminal Electrode Material

First, a terminal electrode material (as an example, a conductive paste) to be a material of the terminal electrodes 151, 152 is prepared. Ag and a polyester-based resin are prepared as conductive materials. The Ag particles may have any shape, but may have a flat shape. The particle size of Ag may be any particle size, and is preferably 0.1 μm to 30 μm. The particle size is preferably 0.5 μm to 20 μm. The term “particle size” as used herein refers to a median diameter (D50) at which a cumulative volume reaches 50% in a volume-based particle size distribution. In addition, the median diameter (D50) is measured using, for example, image analysis or a laser diffraction/scattering type particle distribution measuring apparatus, but is not limited to measurement by the apparatus.

Then, the conductive material and the polyester-based resin are mixed. The conductive material and the polyester-based resin are mixed so as to have a volume ratio in the range of 20/80 to 60/40. Above all, when the volume ratio is in the range of 30/70 to 50/50, the balance of various characteristics is good and suitable. Here, as an additional element, a resin and a solvent may be further contained to form a terminal electrode material. The term “terminal electrode material” as used herein refers to a material capable of forming a flow in a hydrodynamic sense or a material capable of maintaining such a flow. Examples of such materials include liquids such as pastes, solutions or suspensions.

The solvent dissolves the above-mentioned resin binder, and for example, an organic solvent may be used. The organic solvent is not particularly limited, and alcohols including methanol, ethanol, 1-propanol, 2-propanol, hexanol, and cyclohexanol, glycols including ethylene glycol and propylene glycol, ketones including methyl ethyl ketone, diethyl ketone, and methyl isobutyl ketone, terpenes including α-terpineol, β-terpineol, and γ-terpineol, ethylene glycol monoalkyl ethers, ethylene glycol dialkyl ethers, diethylene glycol monoalkyl ethers, diethylene glycol dialkyl ethers, ethylene glycol monoalkyl ether acetates, ethylene glycol dialkyl ether acetates, diethylene glycol monoalkyl ether acetates, diethylene glycol dialkyl ether acetates, propylene glycol monoalkyl ethers, propylene glycol dialkyl ethers, propylene glycol monoalkyl ether acetates, propylene glycol dialkyl ether acetates, and monoalkyl cellosolves can be used alone, a mixture including at least one solvent or two or more solvents selected from these solvents can also be used. As an example of the organic solvent, an alcohol-based solvent such as terpineol is preferably used. A dispersant may be added to the solvent.

After preparing the terminal electrode material, the terminal electrode material is applied to the positive electrode exposed side surface and the negative electrode exposed side surface of the battery element body.

### (3) Firing of Battery Element Body

Although the firing of the battery element body is merely an example, the firing is performed by heating the battery element body in a nitrogen gas atmosphere containing oxygen gas or in the atmosphere at a desired firing temperature (for example, the firing peak temperature is in the range of 300° C. to 600° C.). Firing may be performed while pressurizing the battery element body precursor in the stacking direction (in some cases, stacking direction and direction perpendicular to the stacking direction).

### (4) Application of Terminal Electrode Material

After preparing the terminal electrode material, the terminal electrode material is applied to the positive electrode exposed side surface and the negative electrode exposed side surface of the battery element body.

### (5) Curing of Terminal Electrode Material

The battery element body applied to the positive electrode exposed side surface and the negative electrode exposed side surface is cured at a desired curing temperature (for example, in the range of 100° C. to 300° C.).

### (6) Fixation to Support Substrate

The support substrate is provided with vias and/or lands to enable surface mounting on the secondary board. For example, the support substrate can be obtained by stacking and firing a plurality of green sheets. This is particularly true when the support substrate is a ceramic substrate. The preparation of the support substrate can be performed, for example, in accordance with the preparation of the LTCC substrate.

The via and/or the land in the support substrate is manufactured by, for example, a method of forming a hole (diameter size: about 50 μm to 200 μm) by a punch press, a carbon dioxide laser, or the like and filling the hole with a conductive paste material, or a method using a printing method.

After the support substrate is produced, the conductive portion of the support substrate and the terminal electrode of the battery element body are disposed so as to be electrically connected to each other. In addition, a conductive paste may be provided on the support substrate to thereby electrically connect the conductive portions of the support substrate and the terminal electrodes to each other. As the conductive paste, in addition to an Ag conductive paste, a conductive paste that does not require washing, such as a flux, after formation, such as a nano paste, an alloy-based paste, or a brazing material, can be used.

### (7) Formation of Covering Insulating Film and Inorganic Film

Subsequently, the covering insulating film is formed so as to cover the battery element body on the support substrate. Thus, a raw material of the covering insulating film is provided so that the battery element body on the support substrate is covered as a whole. When the covering insulating film is formed from a resin material, a resin precursor is provided on the support substrate and, for example, cured to mold the covering insulating film.

In a preferred aspect, the covering insulating film may be molded by pressurization with a mold. Although it is merely an example, the covering insulating film that seals the battery element body on the support substrate may be molded through compression molding. In the case of a resin material generally used in a mold, the form of the raw material of the covering insulating film may be granular, and the type thereof may be thermoplastic. Such molding is not limited to die molding, and may be performed through polishing processing, laser processing, and/or chemical treatment.

Next, the inorganic film is formed. For the inorganic film, for example, dry plating may be performed, and a dry plating film may be used as the inorganic film. More specifically, dry plating is performed to form the inorganic film on an exposed surface other than a bottom surface of a covering precursor (that is, other than the bottom surface of the support substrate). In a preferred embodiment, sputtering is performed to form a sputtered film on the exposed outer surface other than the bottom surface of the covering precursor.

Through the above steps, a solid-state battery of the present disclosure can be finally obtained.

### EXAMPLES

### [Evaluation 1: Evaluation on Terminal Electrode Paste]

The elongation at break and the Young's modulus of each of the conductive pastes of Examples 1 to 4 and Comparative Examples 1 to 4 shown in Table 1 below were evaluated. As the conductive material, a flat Ag powder was used, and as the resin, polyester-based resins A to D having different molecular structures, molecular weights, and the like were used. The elongation at break and the Young's modulus were evaluated as follows. An appropriate amount of the conductive paste was dropped onto a glass plate, and a paste coating film was applied using an applicator. The coated film was put into a hot air circulation oven, and heated and cured under standard curing conditions of each paste. The cured coating film was punched into a dumbbell shape using a Thomson blade and used for measurement.

The prepared sample was tested at a test speed of 3 mm/min using a dynamic viscoelasticity (DMA) measuring device (RSA-G2 manufactured by TA Instruments). The dimension at break after the tensile test was measured from the initial dimension (13 mm) before the tensile test. The “elongation at break” was calculated from the obtained initial dimensions and dimensions after breaking. The elongation at break of five samples was measured and calculated, and the average value thereof was adopted.

The Young's modulus was measured by a load unloading test using an ultrafine indentation hardness tester (ENT-1100a manufactured by ELIONIX INC.). More specifically, a Berkovich indenter was used as the indenter, and the Young's modulus was measured by analyzing a curve of displacement when the test was performed with an indentation load of 50 mN. The elongation at break was measured and calculated by preparing three samples for each of Examples and Comparative Examples, and the average value thereof was adopted.

TABLE 1

| | | | | Elonga- | |
|---|---|---|---|---|---|
| | Terminal | Conduc- | | tion at | Young' s |
| | electrode | tive | | break | modulus |
| | materials | material | Resin | (%) | (GPa) |
| Example 1 | Paste A | Ag | Polyester- | 9.6 | 2.3 |
| | | | based | | |
| | | | resin A | | |
| Example 2 | Paste B | Ag | Polyester- | 5.1 | 3.8 |
| | | | based | | |
| | | | resin B | | |
| Example 3 | Paste C | Ag | Polyester- | 7.5 | 3.1 |
| | | | based | | |
| | | | resin C | | |
| Example 4 | Paste D | Ag | Polyester- | 0.9 | 5.8 |
| | | | based | | |
| | | | resin D | | |
| Comparative | Paste E | Ag | Epoxy | 0.3 | 13.9 |
| Example 1 | | | resin A | | |
| Comparative | Paste F | Ag | Epoxy | 0.7 | 6.6 |
| Example 2 | | | resin B | | |
| Comparative | Paste G | Ag | Silicone | 53.5 | 0.5 |
| Example 3 | | | resin A | | |

According to the results of Table 1, in Examples 1 to 4, the elongation at break falls within the range of 0.8% to 50%. On the other hand, in Comparative Examples 1 and 2, the elongation at break was less than 0.8%, and in Comparative Example 3, the elongation at break was higher than 50%.

When the elongation at break is 0.8% or more, it is possible to follow the volume expansion of the battery element body generated when the solid-state battery is charged, and thus, it is possible to reduce the occurrence of cracks in the terminal electrode. On the other hand, when the elongation at break was less than 0.8%, the battery packaging material could not follow the volume expansion of the battery element body of the rechargeable battery, and cracks of the terminal electrode were observed in some places. In addition, when the elongation at break exceeded 50% as in Comparative Example 3, the adhesion force between the battery element body and the terminal electrode was weakened, and peeling between the battery element body and the terminal electrode was observed in some places. In consideration of the above, the terminal electrode of the present disclosure preferably has an elongation at break of 0.8% to 50%.

Further, according to the results of Table 1, in Examples 1 to 4, the Young's modulus falls within the range of 2.0 GPa to 6.0 GPa. On the other hand, in Comparative Examples 1 and 2, the Young's modulus was 6.0 GPa or more, and in Comparative Example 3, the Young's modulus was less than 2.0 GPa.

As described above, when the Young's modulus is 2.0 GPa or more, it is possible to follow the volume expansion of the battery element body generated when the solid-state battery is charged, and thus, it is possible to reduce the occurrence of cracks in the terminal electrode. On the other hand, when the Young's modulus was less than 2.0 GPa, the battery packaging material could not follow the volume expansion of the battery element body of the rechargeable battery, and cracks of the terminal electrode were observed in some places. In addition, when the Young's modulus was 0.5 GPa or less as in Comparative Example 3, the adhesion force between the battery element body and the terminal electrode was weakened, and peeling between the battery element body and the terminal electrode was observed in some places. In consideration of the above, the Young's modulus of the terminal electrode of the present disclosure is preferably 2.0 GPa to 6.0 GPa.

### [Evaluation 2: Evaluation on Electrical Characteristics of Solid-State Battery]

Hereinafter, the electrical characteristics of the solid-state batteries of Examples 1 to 4 and Comparative Examples 1 to 3 were evaluated. The results are shown in Table 2.

TABLE 2

| | Presence and Absence of voltage | ACimp after 100 |
|---|---|---|
| | increase during charge | cycles (Ω) |
| Example 1 | No voltage increase | 52 |
| Example 2 | No voltage increase | 55 |
| Example 3 | No voltage increase | 52 |
| Example 4 | Voltage increase of less than 0.05 V | 54 |
| Comparative | 0.05 V or more | 56 |
| Example 1 | | |
| Comparative | 0.05 V or more | 54 |
| Example 2 | | |
| Comparative | No voltage increase | 129 |
| Example 3 | | |

For the contents of the evaluation test, charge and discharge characteristics of the solid-state battery were measured, and voltage fluctuation during discharge was evaluated. In addition, the AC impedance (ACimp) after the cycle test of the solid-state battery was calculated and evaluated.

For the charge and discharge test and the cycle test of the solid-state battery, a charge and discharge evaluation apparatus TOSCAT-3100 manufactured by Toyo System Co., Ltd. was used. First, the solid-state battery was charged and discharged for 100 cycles under an environment of 60° C. As charge and discharge conditions, during charge, constant current charge was performed at a current value of 0.5 C (current value for complete charge in 2 hours) until the voltage reached 4.1 V, and then constant voltage charge was performed at a voltage of 4.1 V until the current value reached 0.01 C (current value for complete charge in 100 hours). At the time of discharge, constant current discharge was performed at a current value of 0.1 C (current value for complete discharge in 10 hours) until the voltage reached 2.0 V.

For the voltage fluctuation during discharge, it was confirmed whether a voltage increase of 0.05 V or more occurred from the baseline of the discharge curve during discharge. For the ACimp after 100 cycles of charge and discharge, the resistance value of the solid-state battery after the cycle test was measured by an AC impedance method and evaluated.

A Cole-Cole plot from 1 MHz to 1 Hz of the solid-state battery after the cycle test was measured (Apparatus: Impedance gain/phase analyzer SI1260 manufactured by Solartron Instruments), and the end point of the first arc was defined as ACimp. As the value of ACimp is smaller, the input-output characteristics of the battery are improved. When the value of ACimp after the 100 cycle tests was 70Ω or less, it was judged to be good.

According to the evaluation of the AC impedance described in Table 2, in Comparative Examples 1 and 2 (using an epoxy resin), the voltage increase during discharge was 0.05 V or more. On the other hand, in Examples 1 to 4, the voltage increase during discharge was suppressed to less than 0.05 V, and good discharge characteristics were obtained.

In addition, in Comparative Example 3 (using a silicone resin), the value of the AC impedance was 129Ω, which was higher than the value of the AC impedance (70Ω) as a reference, although the increase in voltage during discharge was suppressed. On the other hand, in Examples 1 to 4, since the values of the AC impedance were all below 70Ω, good AC impedance characteristics were obtained.

Note that the embodiments disclosed herein are considered by way of illustration in all respects, and not considered as a basis for restrictive interpretations. Accordingly, the technical scope of the present disclosure is not to be construed only by the embodiments mentioned above, but is defined based on the description of the claims. Further, the technical scope of the present disclosure includes meanings equivalent to the claims and all modifications within the scope. For example, the solid-state battery is not limited to a substantially hexahedral shape, and may have a polyhedral shape, a cylindrical shape, or a spherical shape.

The packaged solid-state battery of the present disclosure can be used in various fields in which battery use or electricity storage is assumed. Although it is merely an example, the packaged solid-state battery of the present disclosure can be used in the electronics packaging field. The present disclosure can be used in electricity, information and communication fields where mobile equipment and the like are used (for example, electrical/electronic equipment fields or mobile device fields including mobile phones, smart phones, laptop computers, digital cameras, activity meters, arm computers, electronic papers, and small electronic devices such as RFID tags, card type electronic money, and smartwatches), domestic and small industrial applications (for example, the fields such as electric tools, golf carts, domestic robots, caregiving robots, and industrial robots), large industrial applications (for example, the fields such as forklifts, elevators, and harbor cranes), transportation system fields (for example, the fields such as hybrid vehicles, electric vehicles, buses, trains, electric assisted bicycles, and two-wheeled electric vehicles), electric power system applications (for example, the fields such as various power generation systems, load conditioners, smart grids, and home-installation type power storage systems), medical applications (medical equipment fields such as earphone hearing aids), pharmaceutical applications (the fields such as dose management systems), IoT fields, and space and deep sea applications (for example, the fields such as spacecraft and research submarines).

### DESCRIPTION OF REFERENCE SYMBOLS

100: Solid-state battery
110: Positive electrode layer
111: Positive electrode active material layer
112: Positive electrode current collector layer
120: Negative electrode layer
121: Negative electrode active material layer
122: Negative electrode current collector layer
130: Solid-state electrolyte layer
140: Battery element body
151: Positive electrode layer-side terminal electrode
152: Negative electrode layer-side terminal electrode
160: Insulating outer layer
200: Covering insulating film
300: Inorganic film
400: Support substrate
410: Wiring
411: Land
412: Via

1. A solid-state battery comprising:
a battery element body including a positive electrode layer, a negative electrode layer, and a solid-state electrolyte layer interposed between the positive electrode layer and the negative electrode layer; and
a terminal electrode on an end surface of the battery element body and electrically connected to the battery element body,
wherein the terminal electrode contains a conductive material and a polyester-based resin.

2. The solid-state battery according to claim 1, wherein the conductive material has a flat shape.

3. The solid-state battery according to claim 1, wherein the conductive material is silver.

4. The solid-state battery according to claim 1, wherein an elongation at break of the terminal electrode is 0.8% to 50%.

5. The solid-state battery according to claim 1, wherein a Young's modulus of the terminal electrode is 2.0 GPa to 6.0 GPa.

6. The solid-state battery according to claim 1, wherein
the solid-state electrolyte layer includes oxide glass and/or oxide glass ceramics, and
the oxide glass and/or the oxide glass ceramics contain at least one selected from the group consisting of lithium, silicon, and boron.

7. The solid-state battery according to claim 1, wherein
the solid-state electrolyte layer includes oxide glass and/or oxide glass ceramics, and
the oxide glass and/or the oxide glass ceramics contain lithium oxide, and
at least one selected from the group consisting of germanium oxide, silicon oxide, boron oxide, and phosphorus oxide.

8. The solid-state battery according to claim 1, wherein the end surface is a side surface of the battery element body that extends in a direction intersecting a stacking direction of the positive electrode layer and the negative electrode layer.

9. The solid-state battery according to claim 8, wherein the terminal electrode extends from the side surface of the battery element body to a bottom surface of the battery element body.

10. The solid-state battery according to claim 8, wherein the terminal electrode extends from the side surface of the battery element body to a top surface and a bottom surface of the battery element body.

11. The solid-state battery according to claim 1, wherein the terminal electrode is a positive electrode-side terminal electrode electrically connected to the positive electrode layer, and the solid-state battery further includes a negative electrode-side terminal electrode electrically connected to the negative electrode layer.

12. The solid-state battery according to claim 11, wherein the negative electrode-side terminal electrode is on a side surface of the battery element that faces the positive electrode-side terminal electrode.

13. The solid-state battery according to claim 1, further comprising a support substrate electrically connected to the terminal electrode.

14. The solid-state battery according to claim 1, further comprising a covering insulating film covering the terminal electrode and the battery element body.

15. The solid-state battery according to claim 14, further comprising an inorganic film covering the covering insulating film.

16. The solid-state battery according to claim 1, wherein the solid-state battery is packaged so as to be surface-mounted.

17. The solid-state battery according to claim 1, wherein the battery element body comprises a sintered body.

18. The solid-state battery according to claim 1, wherein the positive electrode layer and the negative electrode layer are layers capable of occluding and releasing lithium ions.

19. An electronic device comprising:
a substrate; and
the solid-state battery according to claim 1 surface-mounted on the substrate.
